(19) United States
(12) Patent Application Publication
(10) Pub. No.: US 2003/0226711 A1
(43) Pub. Date: Dec. 11, 2003

(54) Integrated differential steering actuator

(76) Inventors: Ratko Menjak, Frankenmuth, MI (US); James M. Card, Linwood, MI (US); Richard H. Leamon, Standish, MI (US)

Correspondence Address: KEITH J. MURPHY, CANTOR COLBURN LLP, 55 Griffin Road South, Bloomfield, CT, 06002, US

(21) Appl. No.: 10/164,207

(22) Filed: Jun. 6, 2002

(51) Int. Cl. B62D 5/04

(52) U.S. Cl. 180/446

(57) ABSTRACT

A differential steering actuator including an input shaft, an output shaft, a motor in operable communication with a vehicle sensor and a differential gear element, wherein the differential gear element is communicated with the input shaft, and the motor so as to translate motion of the input shaft into motion of the output shaft.

### BACKGROUND

Conventional vehicular steering systems have an articulated mechanical linkage connecting an input device (e.g., steering wheel or hand-wheel) to a steering actuator (e.g., steerable road wheel). Even with power assisted steering in an automobile, for example, a typical hand-wheel motion directly corresponds to a resulting motion of the steerable road wheels, substantially unaffected by any assist torque.

This can be seen by referring to FIG. 1. As shown in FIG. 1, a conventional steering system with hydraulic assist, such as that disclosed in U.S. Pat. No. 4,454,801, issued Jun. 19, 1984 to Spann, assigned to the present assignee and wholly incorporated by reference herein, and U.S. Pat. No. 4,828,068, issued May 9, 1989 to Wendler et al., also assigned to the present assignee and wholly incorporated by reference herein, is indicated generally by the reference numeral 10. An intermediate shaft 13 is mechanically linked at an upper end to a hand-wheel. The shaft 13 is fixed at its lower end to a hydraulic valve 12 and a pinion gear element 20, wherein intermediate shaft 13 and pinion gear element 20 include a torsion bar. As the shaft 13 is rotated by the hand-wheel, it causes the torsion bar to twist, thereby actuating a hydraulic system 16 to generate complimentary pressure in a cylinder 18 that urges a piston 22, which is fixed to a rack 30, in the desired direction, thus reducing torque on the pinion 20 and reducing the effort required by the driver. The piston 22 and the rack 30 are formed integrally with a steering rod 25, which includes two ball-joints 24 at either end thereof. The ball-joints 24 provide a connection to a pair of tie-rods 26, which are connected to steerable wheel assemblies in the known manner for turning the steerable wheels of a vehicle.

However, for a vehicular steering system with active steering, such as that used in an automotive front-controlled steering system, a given motion of the hand-wheel may be supplemented by an additional motion, such as that from a differential steering actuator, which translates into a motion of the steerable road wheels that does not necessarily correspond to the given motion of the hand-wheel. Consequently, when the differential steering actuator is inactive, the motion of the steerable road wheels directly corresponds to the hand-wheel motion due to the articulated mechanical linkage, just as in conventional systems.

The term “active steering” relates to a vehicular control system which generates an output that is added to or subtracted from the front steering angle, wherein the output is typically responsive to the yaw and/or lateral acceleration of the vehicle. It is known that, in some situations, an active steering control system may react more quickly and accurately than an average driver to correct transient handling instabilities. In addition, active steering can also provide for variable steering ratios in order to reduce driver fatigue while improving the feel and responsiveness of the vehicle. For example, at very low speeds, such as that which might be experienced in a parking situation, a relatively small rotation of the hand-wheel may be supplemented using an active steering system in order to provide an increased steering angle to the steerable road wheels.

Conventional hydraulic and electric power-assisted steering systems generally lack an active element for providing control over the steering angle independent of a driver's input. This is because prior attempts at adding such an active element have not integrated well with existing systems and/or create too much torque feedback to the driver during active steering control.

### SUMMARY

A differential steering actuator comprising: an input shaft; an output shaft; a motor in operable communication with a vehicle sensor; and a differential gear element, wherein the differential gear element is communicated with the input shaft, the output shaft and the motor so as to translate motion of the input shaft into motion of the output shaft.

### BRIEF DESCRIPTION OF THE DRAWINGS

Referring now to the drawings wherein like elements are numbered alike in the several figures:

FIG. 1 shows a conventional steering system having a hydraulic assist;

FIG. 2 shows a differential steering actuator in accordance with a first embodiment;

FIG. 3 shows a top down cross sectional view of a differential steering actuator in accordance with a first embodiment;

FIG. 4 shows a differential steering actuator in accordance with a second embodiment;

FIG. 5 shows a differential steering actuator for use in an active steering system with electric assist in accordance with a third embodiment;

FIG. 6 shows a differential steering actuator in accordance with a fourth embodiment;

FIG. 7 shows a differential steering actuator in accordance with a fifth embodiment;

FIG. 8 shows a differential steering actuator in accordance with a sixth embodiment;

FIG. 9 shows a differential steering actuator in accordance with a seventh embodiment;

FIG. 10 shows a differential steering actuator in accordance with an eighth embodiment; and

FIG. 11 shows an alternate arrangement of a differential steering actuator in accordance with an ninth embodiment.

### DETAILED DESCRIPTION OF PREFERRED EMBODIMENTS

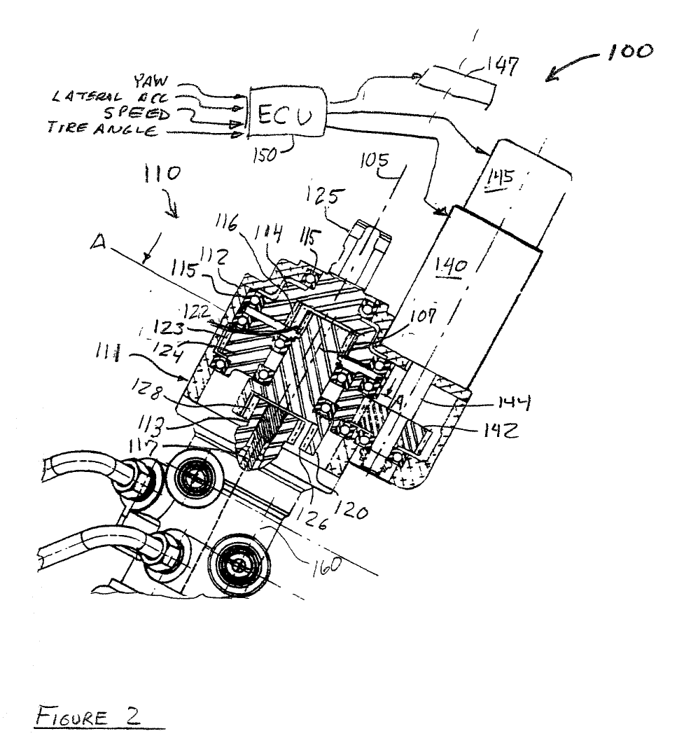

Referring to the figures, an exemplary embodiment is discussed. Referring to FIG. 2, an active steering system 100 having a differential steering actuator 110 in accordance with a first embodiment is shown and discussed. Active steering system 100 preferably includes a gearbox 111, a gear housing 112, an upper shaft 125, a gear element 114, support bearings 115 and a hydraulic power assisted steering mechanism 160 integrated with differential steering actuator 110. In accordance with a first embodiment, gear element 114 and support bearings 115 are preferably disposed within gear housing 112. Support bearings 115 are preferably rotatingly associated with gear element 114 so as to allow gear element 114 to rotate relative to gear housing 112. Upper shaft 125 is preferably communicated with gear element 114 so as to protrude from gear housing 112, wherein upper shaft 125 is non-movably associated with gear element 114 and rotatably associated with gear housing 112. In addition, upper shaft 125 is preferably non-movably associated with a steering shaft that is further non-movably associated with a hand-wheel.

In accordance with a first embodiment, gear element 114 preferably includes an internal gear element 116 having a first pitch circle diameter for rotation on a primary axis 105. Active steering system 100 preferably further includes a bearing support 124 disposed so as to be rotatingly supported within gear housing 112. Furthermore, bearing support 124 preferably includes an external gear element 123 about its periphery, which is in engagement with a pinion 142 fixed to an output shaft 144 of a motor 140. In accordance with a first embodiment, pinion 142 is preferably disposed so as to be parallel with output shaft 144 of motor 140.

In addition, active steering system 100 preferably further includes an eccentric gear element 120 having a secondary axis 107. Eccentric gear element 120 preferably includes a first external gear element 122 having a second pitch circle diameter smaller than the first pitch circle diameter of internal gear element 116, wherein eccentric gear element 120 is preferably disposed such that first external gear element 122 is engagingly associated with internal gear element 116. Moreover, eccentric gear element 120 is preferably disposed within gear housing 112 so as to be rotatingly and eccentrically supported by bearing support 124. As a result, when a stopper 145 holds the output shaft 144 stationary, the bearing support 124 remains stationary, thus preventing the secondary axis 107 from moving about the primary axis 105. Therefore, in response to a rotation of the upper shaft 125, the eccentric gear element 120 is forced to rotate on the secondary axis 107.

The eccentric gear element 120 also preferably has an internal gear element 126 in engagement with a shaft 113, which has a shaft gear element 128 and which is again centered for rotation on the primary axis 105.

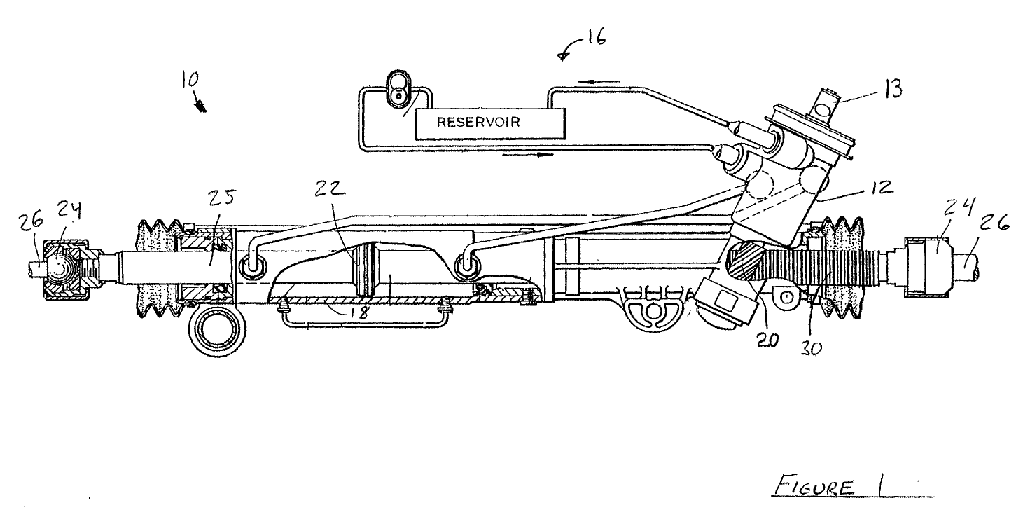

It should be noted, that internal gear element 126 may also be disposed so as to be external to eccentric gear element 120 and shaft gear element 128 maybe disposed so as to be internal to shaft 113. In accordance with an exemplary embodiment, shaft gear element 128 is preferably disposed so as to be engagingly associated with internal gear element 126. Rotation of the shaft 113 causes a torsion bar 117 to twist and thus open a passage for hydraulic fluid as hereinbefore described with respect to FIG. 1. Although not required, a one-to-one turning ratio of the upper shaft 125 and the shaft 113 may be achieved if the internal gear element 126 has a pitch circle of the first diameter being the same as the internal gear element 116, and the shaft 113 has an external gear element having a pitch circle of the second diameter being the same as the eccentric gear element 120. In accordance with an exemplary embodiment, different turning ratios of the upper shaft 125 and the shaft 113 may be achieved by varying the pitch circle of the first diameter and/or the pitch circle of the internal gear element 126 and/or the pitch circle of the shaft 113 and/or the pitch circle of the eccentric gear element 120.

A stopper-damper 147 is optionally located on the steering shaft. Stopper-damper 147 preferably functions to hold upper shaft 125 without rotation in case of active steering intervention such that a driver does not feel the additional steering input. The stopper-damper 147 may also function to damp vibrations at relatively high vehicle speeds.

An electronic control unit 150 preferably receives inputs from various vehicle sensors (yaw, lateral acceleration, speed, etc.), and generates output signals to control electric motor 140, stopper 145 and stopper-damper 147. For example, electronic control unit 150 may receive such inputs as yaw, lateral acceleration, speed, steerable wheel angle, and tire slip angle from various sensors. Alternatively, yaw may be approximated rather than sensed as taught by U.S. Pat. No. 6,205,391, issued Mar. 20, 2001, to Ghoneim et al., which is assigned to the present assignee and wholly incorporated by reference herein. Upon detecting that corrective stabilizing action is required based on inputs from the various sensors, electronic control unit 150 preferably communicates this action to electric motor 140 so as to cause electric motor 140 to respond.

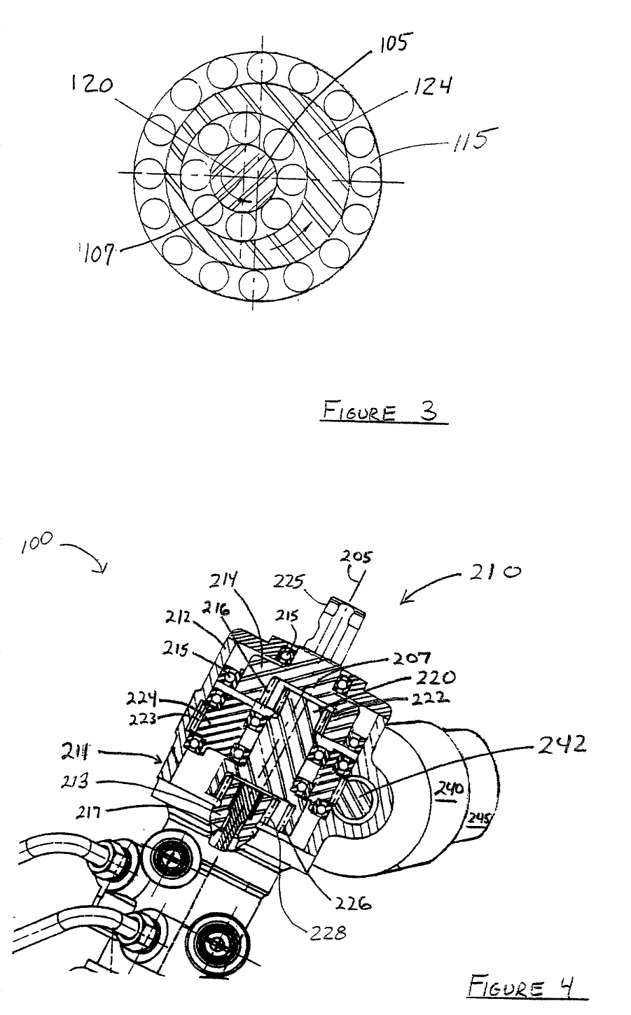

Referring to FIG. 3, a cross section taken along section A-A of FIG. 2 is shown, in accordance with an exemplary embodiment. As can be seen, eccentric gear element 120 is supported by a first bearing set for rotation on a secondary axis 107 within the bearing support 124, which is in turn supported by support bearings 115 disposed so as to allow for rotation on the primary axis 105. The position of bearing support 124 defines the position of secondary axis 107 on which eccentric gear element 120 rotates. Thus, eccentric gear element 120 rotates on its own axis extending down the center of its body, which is secondary axis 107, and can also rotate on primary axis 105, which is parallel to secondary axis 107.

Referring to FIG. 2 and FIG. 3, under normal operating conditions, when a driver rotates the hand-wheel, this rotational motion is translated to upper shaft 125 via the steering shaft. The rotation of upper shaft 125 is, in turn, translated to gear element 114, so as to cause gear element 114 to rotate about primary axis 105 relative to gear housing 112. If electric motor 140 causes output shaft 144 to rotate in response to a signal from electronic control unit 150, pinion 142 will also rotate. This in turn will interact with external gear element 123 and cause bearing support 124 to rotate about secondary axis 107. Thus, eccentric gear element 120 is simultaneously rotating about secondary axis 107 and primary axis 105. If electric motor 140 causes stopper 145 to hold output shaft 144 stationary, pinion 142 will also be stationary. This in turn will interact with external gear element 123 so as to cause bearing support 124 to remain stationary. Thus, eccentric gear element 120 will only rotate about secondary axis 107.

In either of the two situations described hereinabove, when eccentric gear element 120 rotates, internal gear element 126 and shaft gear element 128 will engage each other and cause shaft 113 to rotate. This action will then be translated to the road-wheels as described hereinabove.

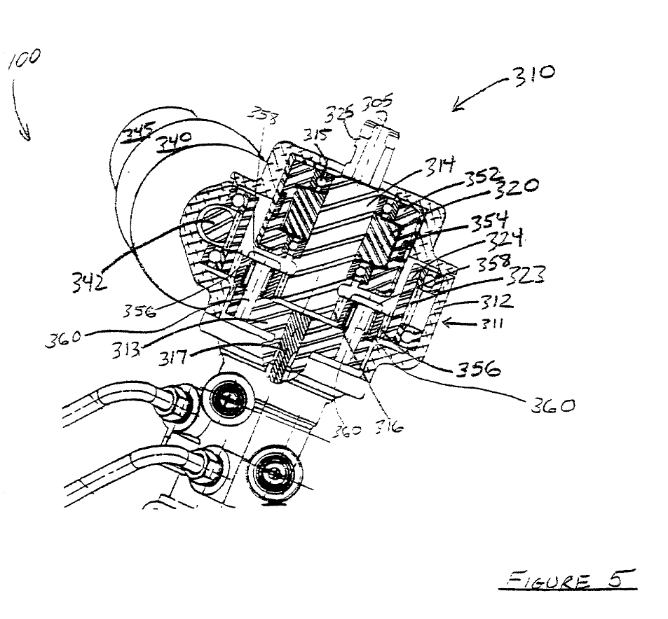

Referring to FIG. 4, a second embodiment of active steering system 100 having a differential steering actuator 210 is shown and discussed. In accordance with a second embodiment, elements in FIG. 4 that are the same or similar as elements in FIG. 2 are identified via a 200 series number. For example, a gear housing 112 in FIG. 2 is identified as a gear housing 212 in FIG. 4. In accordance with a second embodiment, active steering system 100 incorporates the elements of the first embodiment, with the exception of pinion 142. Differential steering actuator 210 operates similarly to differential steering actuator 110 with the exception that the input from electronic control unit 150 is effected via a worm gear 242 communicated with electric motor 240, as opposed to the first embodiment which uses pinion 142. In accordance with a second embodiment, worm gear 242 is preferably movingly associated with external gear element 223.

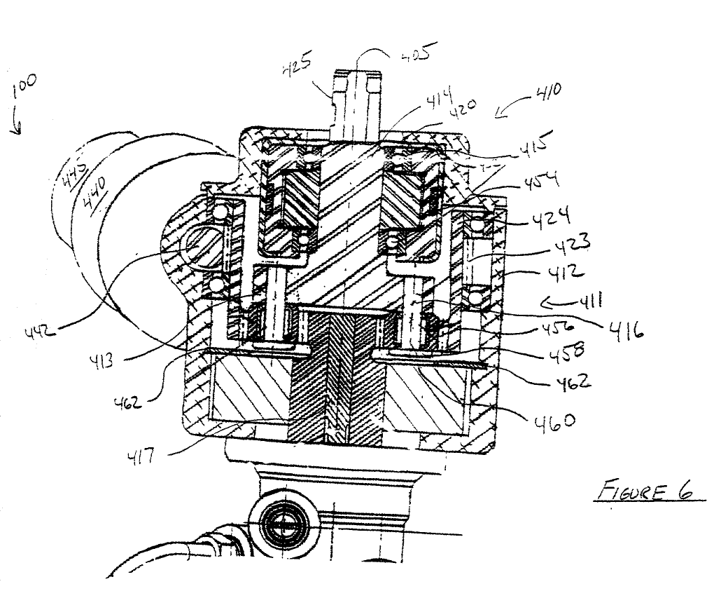

Referring to FIG. 5, a third embodiment is of active steering system 100 having a differential steering actuator 310 is shown and discussed. In accordance with a third embodiment, differential steering actuator 310 primarily differs from the second embodiment of differential steering actuator 210 shown in FIG. 4 by the addition of planetary gear elements 356. As described with respect to FIG. 2, under normal conditions a driver rotates a hand-wheel that rotates a steering shaft, which is communicated with an upper shaft 325. Upper shaft 325 is communicated with a gear element 314, which is rotatably supported by bearings 315 within a gear housing 312 of a gearbox 311.

In accordance with a third embodiment, gear element 314 preferably includes an external gear element 316 having a pitch circle diameter for rotation on an axis 305. In engagement with external gear element 316 are planetary gear elements 356. Planetary gear elements 356 are preferably each rotatably supported on spindle supports 358, which are, in turn, rotatably supported in gear housing 312. In addition, planetary gear elements 356 preferably include individual axes 360 and have a pitch circle diameter sized so as to allow engagement with external gear element 316 of gear element 314. Spindle supports 358 are also preferably disposed so as to allow planetary gear elements 356 to interact with an external worm gear element 323 about their periphery, which is in engagement with a worm 342 communicated with an output shaft of a motor 340 having a stopper 345. In accordance with a third embodiment, motor 340 is preferably communicated with an electronic control unit so as to receive control signals from the electronic control unit responsive to various vehicle sensors (yaw, lateral acceleration, speed, etc.).

When upper shaft 325 rotates, this causes gear element 314 and thus external gear element 316 to rotate. As a result, external gear element 316 interacts with planetary gear elements 356 causing planetary gear elements 356 to rotate. If the electronic control unit causes stopper 345 to hold the output shaft stationary, worm 342 will remain stationary and thus spindle supports 358 remain stationary preventing spindle supports 358 from moving about axis 305. In this case, in response to a rotation of upper shaft 325, planetary gear elements 356 are forced to rotate only about their individual axes 360.

However, if the electronic control unit causes motor 340 to rotate the output shaft, worm 342 will rotate causing external worm gear element 323 to rotate. This, in turn, will cause spindle supports 358 to rotate about axis 305. preventing spindle supports 358 from moving about axis 305. In this case, in response to a rotation of upper shaft 325, planetary gear elements 356 will simultaneously rotate about axis 305 and their individual axes 360.

In accordance with a third embodiment, spindle supports 358 of planetary gear elements 356 are preferably communicated with an output shaft 313, which is centered for rotation on axis 305. Rotation of output shaft 313 causes a torsion bar 317 to openingly engage a passage for hydraulic fluid as described hereinabove. Although not required, a one-to-one turning ratio of upper shaft 325 and output shaft 313 may be achieved if external gear element 316 has a pitch circle of the first diameter being the same as planetary gear elements 356. In accordance with an exemplary embodiment, different turning ratios of upper shaft 325 and the output shaft 313 may be achieved by varying the pitch circle of external gear element 316 and/or the pitch circle of planetary gear elements 356.

Referring to FIG. 6, a fourth embodiment of active steering system 100 having a differential steering actuator 410 is shown and discussed. In accordance with a fourth embodiment, active steering system 100 incorporates all of the elements of the third embodiment, with the exceptions that the components of differential steering actuator 410 have a different orientation than that of the third embodiment and that a position sensor 462 is included and is preferably disposed so as to be adjacently associated with output shaft 413, wherein position sensor 462 preferably produces a signal responsive to the position of output shaft 413. In accordance with a fourth embodiment, position sensor 462 is preferably further communicated with an electronic control unit, so as to inform the electronic control unit of the position of output shaft 413, wherein the electronic control unit may communicate a signal responsive to position sensor 462 to a motor 440, so as to cause motor 440 to respond.

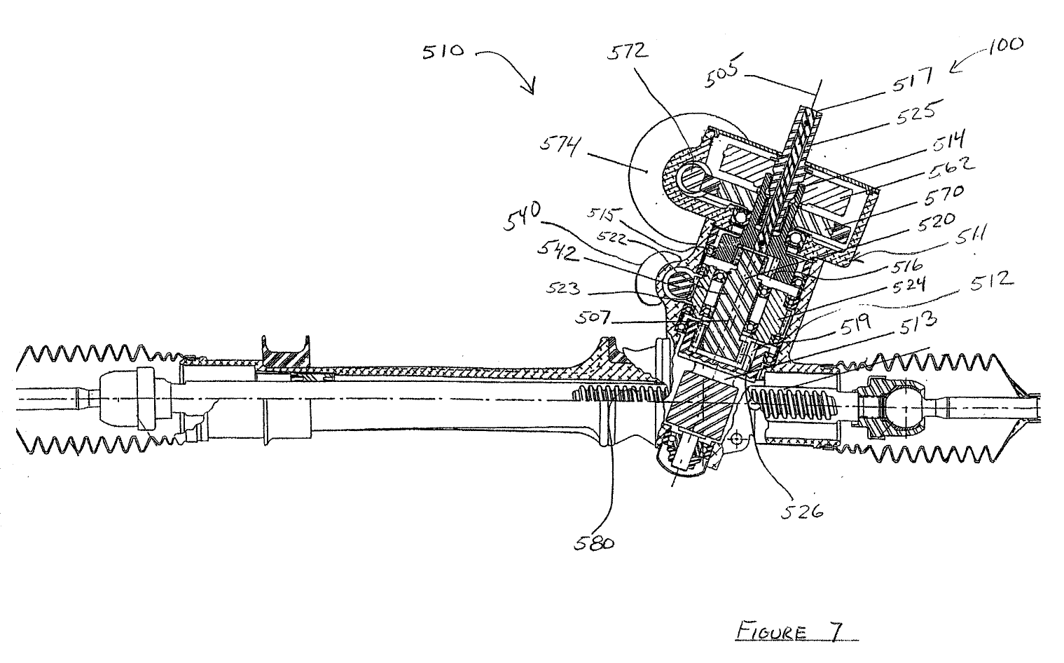

Referring to FIG. 7, a fifth embodiment of an active steering system 100 having a differential steering actuator 510 is shown and discussed. Under normal conditions, a driver rotates a hand-wheel that rotates a steering shaft, which is communicated with an upper shaft 525. Upper shaft 525 is further communicated with a gear element 514, which is rotatably supported by bearings 515 within a gear housing 512 of a gearbox 511. In accordance with a fifth embodiment, differential steering actuator 510 preferably includes a torsion bar 517, a torque sensor 562 and a yaw sensor. Torque sensor 562 is preferably disposed so as to be communicated with upper shaft 525 and an electronic control unit, wherein torque sensor 562 senses the torque on upper shaft 525 and communicates a signal, responsive to the torque on upper shaft 525, to the electronic control unit. In addition, yaw sensor is also preferably communicated with the electronic control unit and disposed so as to sense the yaw of the vehicle. Yaw sensor then communicates a signal, responsive to the yaw of the vehicle, to the electronic control unit.

In accordance with a fifth embodiment, gear element 514 includes an internal gear element 516 having a first pitch circle diameter for rotation on a primary axis 505. In engagement with internal gear element 516 is an eccentric gear element 520. Eccentric gear element 520 is preferably rotatably and eccentrically supported in a bearing support 524, which is, in turn, rotatably supported in gear housing 512. Differential steering actuator 510 preferably includes a torque worm gear element 570 which is in engagement with gear element 514 and a torque worm 572, wherein torque worm 572 is fixed to an output shaft of torque motor 574. When a torque stopper holds the output shaft of torque motor 574 stationary, gear element 514 remains stationary, thus preventing gear element 514 from rotating about primary axis 505.

In addition, eccentric gear element 520 preferably includes a secondary axis 507 and a first external gear element 522 having a second pitch circle diameter smaller than the first pitch circle diameter in engagement with internal gear element 516 of gear element 514. Bearing support 524 preferably includes an external yaw worm gear element 523 about its periphery, which is in engagement with a yaw worm 542 fixed to an output shaft of a motor 540. When a yaw stopper holds the output shaft of motor 540 stationary, bearing support 524 remains stationary, thus preventing eccentric gear element 520 from rotating about secondary axis 507. Thus, in response to a rotation of upper shaft 525, eccentric gear element 520 is forced to rotate only on primary axis 505.

Moreover, eccentric gear element 520 also preferably includes an internal gear element 526 disposed so as to be engagedly associated with an output shaft element 519 of an output shaft 513, wherein output shaft 513 is centered for rotation on primary axis 505. Rotation of output shaft 513 causes a torsion bar 517 to engage a rack 580, wherein rack 580 is communicated with the road-wheels. Torsion bar 517 causes rack 580 to move left or right, thus translating the action of output shaft 513 to the road-wheels.

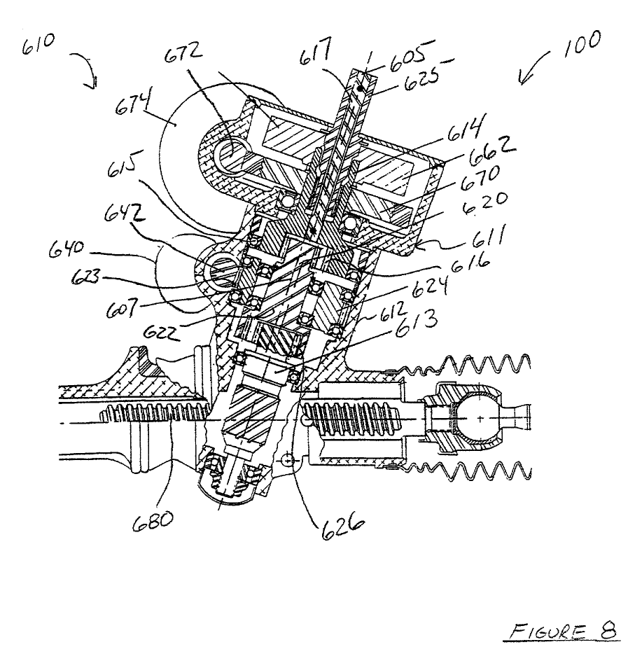

Referring to FIG. 8, a sixth embodiment of active steering system 100 having a differential steering actuator 610 is shown and discussed. In accordance with a sixth embodiment, active steering system 100 incorporates all of the elements of the fifth embodiment, with the exception that different gear ratios may be achieved by varying the sizes of gear element 614 and output shaft 613. In accordance with an exemplary embodiment, different turning ratios of the upper shaft 625 and the output shaft 613 may be achieved by varying the size of the first pitch circle diameter of internal gear element 616 and/or the second pitch circle diameter of first external gear element 622. In addition, different turning ratios of upper shaft 625 and output shaft 613 may also be achieved by varying the size of internal gear element 616 and/or external gear element 622. In accordance with a sixth embodiment, the ratio between gear element 614 and output shaft 613 may be any ratio suitable to the desired end purpose.

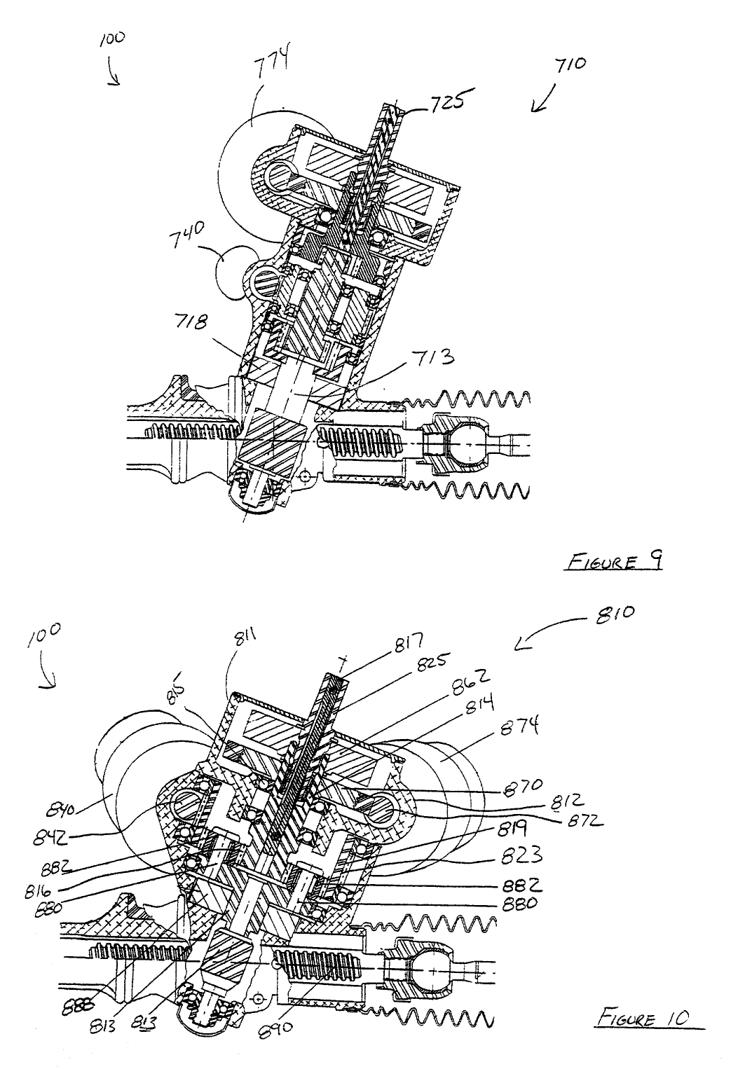

Referring to FIG. 9, a seventh embodiment of active steering system 100 having a differential steering actuator 710 is shown and discussed. In accordance with a seventh embodiment, active steering system 100 incorporates all of the elements of the fifth embodiment, with the exception that a position sensor 718 has been added. In accordance with a seventh embodiment, position sensor 718 is preferably disposed so as to be communicated with output shaft 713, wherein position sensor 718 measures tire position and communicates that measurement to an electronic control unit. The electronic control unit then communicates with motor 740 and/or torque motor 774 so as to cause motor 740 and/or torque motor 774 to respond in a manner responsive position sensor 718.

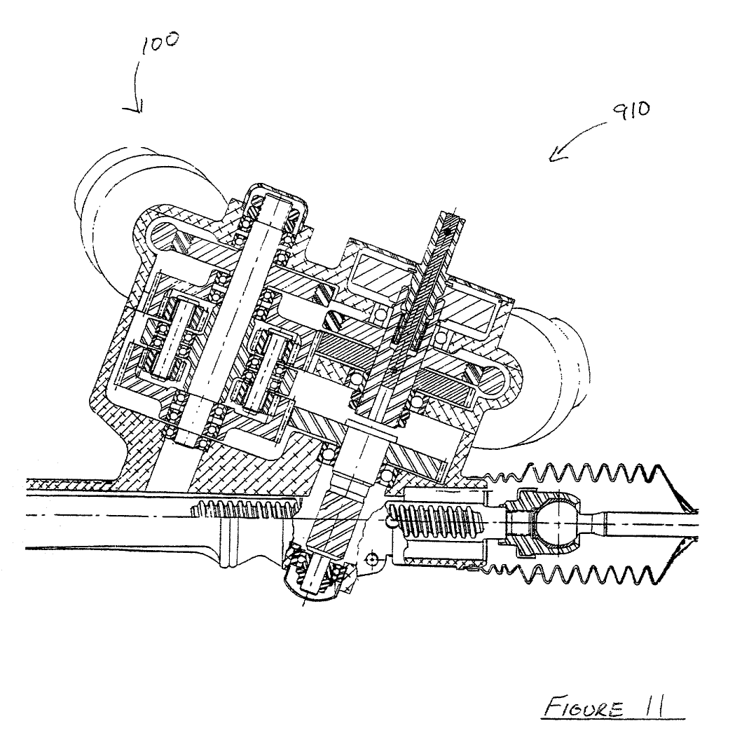

Referring to FIG. 10, an eighth embodiment of active steering system 100 having a differential steering actuator 810 is shown and discussed. Under normal conditions, a driver rotates a hand-wheel that rotates a steering shaft, which is communicated with an upper shaft 825. Upper shaft 825 is further communicated with a gear element 814, which is rotatably supported by bearings 815 within a gear housing 812 of a gearbox 811.

In accordance with an eighth embodiment, active steering system 100 differential steering actuator 810 preferably includes a torsion bar 817, a torque sensor 862 and a yaw sensor. Torque sensor 862 is preferably disposed so as to be communicated with upper shaft 825 and an electronic control unit, wherein torque sensor 862 senses the torque on upper shaft 825 and communicates a signal, responsive to the torque on upper shaft 825, to the electronic control unit. In addition, yaw sensor is also preferably communicated with the electronic control unit and disposed so as to sense the yaw of the vehicle. Yaw sensor then communicates a signal, responsive to the yaw of the vehicle, to the electronic control unit.

In accordance with an eighth embodiment, gear element 814 preferably includes an external gear element 816. Differential steering actuator 810 preferably includes a torque worm gear element 870 which is in engagement with gear element 814 and a torque worm 872, wherein torque worm 872 is fixed to an output shaft of torque motor 874. In addition, differential steering actuator 810 also includes a yaw worm gear 819 having a yaw worm gear element 823 about its periphery, which is in engagement with a yaw worm 842 fixed to an output shaft of a yaw motor 840. Moreover, Differential steering actuator 810 also preferably includes a planetary gear 880 having planetary gear elements 882 in engagement with external gear element 816.

In accordance with an eighth embodiment, differential steering actuator 810 also includes an output shaft 813 and an output shaft support 884 having shaft gear elements 886, wherein shaft gear elements 886 are in engagement with planetary gear elements 882.

When a driver rotates the hand-wheel, the hand-wheel rotates a steering shaft, which in turn rotates upper shaft 825. Torsion bar 817 twists in response to the rotation of upper shaft 825. Torque sensor 862 sends a signal to the electronic control unit 150 which informs torque motor 874 to rotate torque worm 872 causing worm gear element 870 to rotate. This causes gear element 814 to rotate, which causes planetary gears 880 to rotate, which in turn causes an output shaft support 813 to rotate causing a rack 890 to move left or right. When a driver does not rotate the hand-wheel and the vehicle is traveling in a straight path, the yaw sensor senses the yaw rate of the vehicle and communicates a signal to the electronic control unit which informs yaw motor 840 to rotate yaw worm 842 causing yaw worm gear 819 to rotate. This causes planetary gears 880 to rotate around gear element 814 thus causing output shaft support 813 to rotate causing rack 890 to move left or right. In accordance with an eighth embodiment, yaw motor 840 and torque motor 874 may operate in a manner responsive to a position sensor 888.

In accordance with a ninth embodiment, the elements of active steering system 100 having a differential steering actuator 910 maybe arranged in any manner suitable to the desired end purpose as shown in FIG. 11.

While the description has been made with reference to exemplary embodiments, it will be understood by those of ordinary skill in the pertinent art that various changes may be made and equivalents may be substituted for the elements thereof without departing from the scope of the disclosure. In addition, numerous modifications may be made to adapt the teachings of the disclosure to a particular object or situation without departing from the essential scope thereof.

For example, the present teachings may be applied to general control algorithms wherein the actuation is preferably smoothed to optimize the man-machine interface. Such control algorithms may include, but are not limited to, input devices such as pedals and actuators such as linear motors, and more generally, any controlled device in contact with human skin. It is understood that such control algorithms have application to lane-keeping in addition to hand-wheel actuation. Therefore, it is intended that the Claims not be limited to the particular embodiments disclosed as the currently preferred best modes contemplated for carrying out the teachings herein, but that the Claims shall cover all embodiments falling within the true scope and spirit of the disclosure.

What is claimed is:

1. A active steering system comprising:
an input shaft;
an output shaft;
a motor in operable communication with a vehicle sensor; and
a differential gear element, wherein said differential gear element is communicated with said input shaft, said output shaft and said motor so as to translate motion of said input shaft into motion of said output shaft, wherein said motion of said output shaft is further responsive to said motor.

2. An active steering system according to claim 1, wherein said input shaft is communicated with a hand-wheel.

3. An active steering system according to claim 1, wherein said motor is communicated with said vehicle sensor via an engine control unit.

4. An active steering system according to claim 1, further comprising:
a pinion disposed relative to said output shaft; and
a rack meshingly engaged with said pinion.

5. An active steering system according to claim 4, further comprising:
an output rod disposed relative to said rack for translating rotation of said output shaft into motion of said output rod.

6. An active steering system according to claim 1, further comprising:
a steering box configured to effect a steering ratio between said output shaft and a road wheel.

7. An active steering system according to claim 1, said differential gear element being operably disposed relative to a vehicular active steering system.

8. An active steering system comprising:
an input device;
a differential steering actuator in operable communication with said input device; and
a motor in operable communication with said differential steering actuator.

9. An active steering system according to claim 8, wherein said differential steering actuator is configured to provide a steering angle that is substantially independent of an input from said input device.

10. An active steering system as defined in claim 8 wherein said differential steering actuator comprises:
a differential gear element having an input shaft and an output shaft; and
a worm gear element communicated with said differential gear element, wherein said worm gear element rotates independently from said input shaft.

11. An active steering system as defined in claim 10 wherein said motor is in operable communication with said worm gear element so as to drive said worm gear element.

12. An active steering system as defined in claim 8, further comprising a controller in signal communication with said motor.
